(19) United States
(12) Patent Application Publication
(10) Pub. No.: US 2018/0286167 A1
(43) Pub. Date: Oct. 4, 2018

(54) Method for sharing electric power-assisted bicycle

(71) Applicants: Yijun XU, Suzhou (CN); Yijie XU, Suzhou (CN)

(72) Inventors: Yijun XU, Suzhou (CN); Yijie XU, Suzhou (CN)

(21) Appl. No.: 15/498,488

(22) Filed: Apr. 27, 2017

(30) Foreign Application Priority Data
Mar. 30, 2017 (CN) 201710204053.9

(51) Int. Cl. G07F 17/00; B62M 6/40; B62M 6/90; B62M 3/08; B60L 11/18; G06Q 30/06

(52) U.S. Cl. CPC G07F 17/0057; B62M 6/40; B62M 6/90; G06Q 2240/00; B60L 11/1809; G06Q 30/0645; B60L 2200/12; B62M 3/08

(57) ABSTRACT

The present invention relates to the technical field of public transportation, and discloses a method for sharing an electric power-assisted bicycle. The method includes: unlocking a bicycle lock of the electric power-assisted bicycle by means of scanning a code; and installing a self-brought power source on the electric power-assisted bicycle. The method for sharing an electric power-assisted bicycle in the present invention solves the problem of power source charging and the problem of being tired in riding a shared bicycle by means of a user's self-brought power source, and shares the electric power-assisted bicycle without sharing; the power source. The method can be popularized in a large scale, has a wide market prospect, and can also enable a user to take more care of the electric power-assisted bicycle during riding, thereby increasing the service life of the electric power-assisted bicycle.

### CROSS REFERENCE TO RELATED APPLICATIONS

This application is based upon and claims priority to Chinese Patent Application No.: 201710204053.9 filed on Mar. 30, 2017, the entire contents of which are incorporated herein by reference.

### TECHNICAL FIELD

The present invention relates to the technical field of public transportation, and in particular, to a method for sharing an electric power-assisted bicycle.

### BACKGROUND

With the continuous development of Internet technologies, people's travel modes are also changing. Sharing travel in sharing economy has become a fashion, trend and future. Shared bicycles and shared electric power-assisted bicycles emerged as one of the shared transport medium. However, the problems of being tired in riding and unsuitability for middle-distance and long-distance travels exists in shared bicycles. The charging of electric power-assisted bicycles is a difficult question. Although the problem of middle-distance and long-distance travels can be solved by the same, and the difficulty in charging results in the fact that the electric power-assisted bicycles cannot be freely placed and picked up as the shared bicycles, and this also becomes an important reason why the shared electric power-assisted bicycles cannot be promoted in a large scale at present.

### SUMMARY OF THE INVENTION

With respect to the disadvantages of the prior art, the present invention is intended to provide a method for sharing an electric power-assisted bicycle which can solve both the problem of charging the electric power-assisted bicycle and the problem of being tired in riding a shared bicycle and is thus suitable for large-scale promotion.

To achieve the above objectives, the following technical solutions are adopted in the present invention:

A method for sharing an electric power-assisted bicycle, comprising:
unlocking a bicycle lock of the electric power-assisted bicycle b means of scanning a code; and
installing a self-brought power source on the electric power-assisted bicycle.

As a further improvement to the present invention, prior to unlocking a bicycle lock of the electric power-assisted bicycle by means of scanning a code, the method further comprises:
searching for surrounding electric power-assisted bicycles via a mobile terminal.

As a further improvement to the present invention, the electric power-assisted bicycle is installed with an automatic charging apparatus, and the automatic charging apparatus is used for converting excess kinetic energy into electric energy during riding to charge the power source.

As a further improvement to the present invention, the means of scanning a code particularly comprises:
scanning an identification code on the electric power-assisted bicycle via a mobile terminal or scanning an identification code on the mobile terminal via a scanning apparatus on the electric power-assisted bicycle.

As a further improvement to the present invention, after installing a self-brought power source on the electric power-assisted bicycle, the method further comprises:
returning the electric power-assisted bicycle after the end of use; and
automatically locking the electric power-assisted bicycle.

As a further improvement to the present invention, after automatically locking the electric power-assisted bicycle, the method further comprises:
paying fees according to the mileage or time of riding.

As a further improvement to the present invention, after automatically locking the electric power-assisted bicycle, the method further comprises:
sending prompt information to remind a user to take away the power source.

As a further improvement to the present invention, the prompt information is voice information.

As a further improvement to the present invention, the electric power-assisted bicycle is installed with pedals, and a user is able to ride assisted by the power source and is also able to completely use the pedals for riding.

As a further improvement to the present invention, the power source is installed on the electric power-assisted bicycle by means of plugging.

Compared to the prior art, the method for sharing an electric power-assisted bicycle in the present invention solves the problem of power source charging and the problem of being tired in riding a shared bicycle by means of a user's self-brought power source and shares (sharing) the electric power-assisted bicycle without sharing the power source. The method can be popularized in a large scale, has a wide market prospect, and can also enable a user to take more care of the electric power-assisted bicycle during riding, thereby increasing the service life of the electric power-assisted bicycle.

The description above is only a summary of the technical solution of the present invention. In order to more clearly understand the technical means of the present invention for implementation according to the contents of the description, and to make the above and other objectives, features and advantages of the present invention more apparent and easy to be understood, preferred embodiments are especially taken as examples in conjunction with the accompanying drawings, and the detailed description is as follows.

### BRIEF DESCRIPTION OF THE DRAWINGS

FIG. 1 is a schematic diagram of a method for sharing an electric power-assisted bicycle in an embodiment of the present invention.

### DETAILED DESCRIPTION OF THE INVENTION

The present invention is further described below in conjunction with the accompanying drawings and specific embodiments.

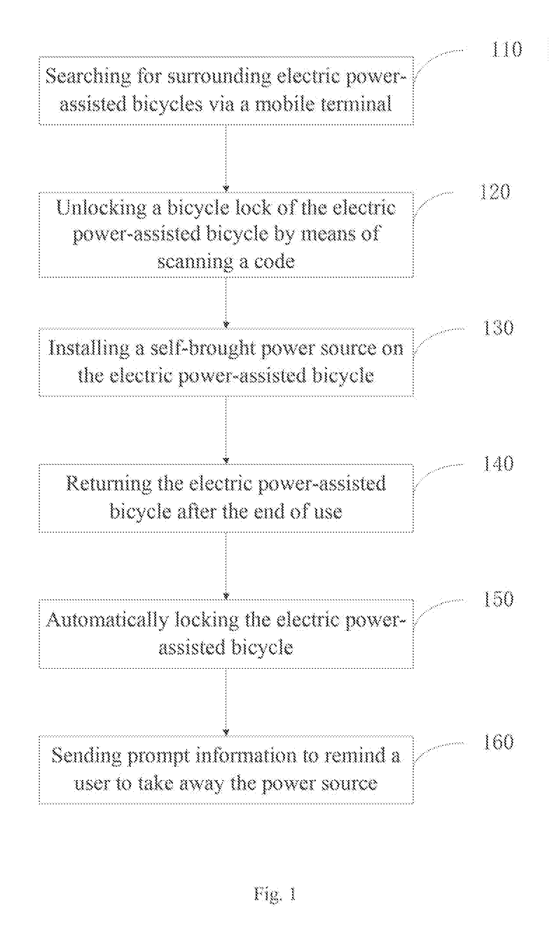

FIG. 1 shows a method for sharing an electric power-assisted bicycle in an embodiment of the present invention, the method comprising the steps of:

Step 110, searching for surrounding electric power-assisted bicycles via a mobile terminal.

Preferably, the mobile terminal is a mobile device such as a mobile phone, a tablet computer, etc.

Step 120, unlocking a bicycle lock of the electric power-assisted bicycle by means of scanning a code.

The means of scanning a code particularly comprises: scanning an identification code on the electric power-assisted bicycle via a mobile terminal or scanning an identification code on the mobile terminal via a scanning apparatus on the electric power-assisted bicycle.

Preferably, the mobile terminal is a mobile device such as a mobile phone, a tablet computer, etc.

Step 130, installing a self-brought power source on the electric power-assisted bicycle.

Particularly, a socket for installing the power source is provided on the electric power-assisted bicycle and the power source is installed on the electric power-assisted bicycle by means of plugging, etc. During riding, the power source supplies electric energy to the electric power-assisted bicycle, which can alleviate the pressure of people in riding and make the riding more relaxed and labour-saving.

Preferably, a user is able to ride assisted by the power source and is also able to completely use the pedals for riding; and
preferably, the power source can be purchased or rented, and the power source is small in volume and is provided with an interface for charging an electronic device, and is equivalent to a portable power source.

Step 140, returning the electric power-assisted bicycle after the end of use.

Preferably, the electric power-assisted bicycle can be returned to any designated region.

Step 150, automatically locking the electric power-assisted bicycle.

Particularly, returning the electric power-assisted bicycle is set in the mobile terminal, and after the electric power-assisted bicycle receives information, a locking operation is completed.

Preferably, the mobile terminal is a mobile device such as a mobile phone, a tablet computer, etc.

Step 160, sending prompt information to remind a user to take away the power source.

Preferably, the prompt information is voice information.

Preferably, after step 150, the method further comprises the step of:
paying fees according to the mileage or time of riding; and

Particularly, payment is conducted by means of AliPay, WeChat or a bank card, etc.

Preferably, the electric power-assisted bicycle is installed with an automatic charging apparatus, and the automatic charging apparatus is used for converting excess kinetic energy into electric energy during riding so as to charge the power source, and
this is beneficial to utilize the excess kinetic energy downhill, which can enable a farther distance of riding of the electric power-assisted bicycle.

Compared to the prior art, the method for sharing an electric power-assisted bicycle in the present invention solves the problem of power source charging and the problem of being tired in riding a shared bicycle by means of a user's self-brought power source and shares the electric power-assisted bicycle without sharing the power source. The method can be popularized in a large scale, has a wide market prospect, and can also enable a user to take more care of the electric power-assisted bicycle during riding, thereby increasing the service life of the electric power-assisted bicycle.

For those skilled in the art, various other corresponding changes and variations can be made according to the technical solutions and conceptions described above, while all these changes and variations should fall within the scope of protection of the claims of the present invention.

1. A method for sharing an electric power-assisted bicycle, comprising:
unlocking a bicycle lock of the electric power-assisted bicycle by means of scanning a code; and
installing a self-brought power source on the electric power-assisted bicycle.

2. The method for sharing an electric power-assisted bicycle of claim l, wherein prior to unlocking a bicycle lock of the electric power-assisted bicycle by means of scanning a code, the method further comprises:
searching for surrounding electric power-assisted bicycles via a mobile terminal.

3. The method for sharing an electric power-assisted bicycle of claim 1, wherein the electric power-assisted bicycle is installed with an automatic charging apparatus, the automatic charging apparatus being used for converting excess kinetic energy into electric energy during riding so as to charge the power source.

4. The method for sharing an electric power-assisted bicycle of claim 1, wherein the means of scanning a code particularly comprises:
scanning an identification code on the electric power-assisted bicycle via a mobile terminal or scanning an identification code on the mobile terminal via a scanning apparatus on the electric power-assisted bicycle.

5. The method for sharing an electric power-assisted bicycle of claim 1, wherein after installing a self-brought power source on the electric power-assisted bicycle, the method further comprises:
returning the electric power-assisted bicycle after use; and
automatically locking the electric power-assisted bicycle.

6. The method for sharing an electric power-assisted bicycle of claim 5, wherein after automatically locking the electric power-assisted bicycle, the method further comprises:
paying fees according to mileage or time of riding.

7. The method for sharing an electric power-assisted bicycle of claim 5, wherein after automatically locking the electric power-assisted bicycle, the method further comprises:
sending a prompt information to remind a user to take away the power source.

8. The method for sharing an electric power-assisted bicycle of claim 7, wherein the prompt information is voice information.

9. The method for sharing an electric power-assisted bicycle of claim 1, wherein the electric power-assisted bicycle is installed with pedals, such that the pedals can be used for riding.

10. The method for sharing an electric power-assisted bicycle of claim 1, wherein the power source is installed on the electric power-assisted bicycle by means of plugging.
